(19) United States
(12) Patent Application Publication
(10) Pub. No.: US 2023/0099905 A1
(43) Pub. Date: Mar. 30, 2023

(54) MOTOR VEHICLE HAVING A MEANS FOR RELEASING THE FRONT WHEEL IN THE EVENT OF FRONTAL IMPACT

(71) Applicant: PSA AUTOMOBILES SA, Poissy (FR)

(72) Inventors: Mihaela Maria MAGAS, Autrey Les Cerre (FR); Ronan BREAL, Bethoncourt (FR)

(21) Appl. No.: 17/790,452

(22) PCT Filed: Jan. 18, 2021
(86) PCT No.: PCT/FR2021/050080

§ 371 Date: Jun. 30, 2022

(30) Foreign Application Priority Data
Jan. 22, 2020 (FR) FR2000615

(51) Int. Cl. B62D 21/15; B62D 25/04

(52) U.S. Cl. CPC B62D 21/152; B62D 25/04; B62D 25/08

(57) ABSTRACT

The present invention relates to a motor vehicle having a front wheel consisting of a rim with an inner sidewall and an underbody structure comprising a front longitudinal member (1), an A-pillar (3) and a connecting piece (5) between the front longitudinal member (1) and the A-pillar (3), the connecting piece (5) being located at the back of the front wheel. The vehicle is characterized in that the connecting piece (5) has a bearing element (7) with a raised section (9) projecting toward the front of the vehicle, the raised section (9) extending in the transverse direction of the vehicle.

### CROSS-REFERENCE TO RELATED APPLICATIONS

This application is the US National Stage under 35 USC § 371 of International Application No. PCT/FR2021/050080, filed Jan. 18, 2021 which claims the priority of French App. No. 2000615 filed Jan. 22, 2020, the content (text, drawings and claims) of both said applications being incorporated here by reference.

### BACKGROUND

The present invention relates to a motor vehicle, more particularly to a motor vehicle reinforced to protect users in the event of a frontal impact.

The test protocols for a vehicle in the context of a frontal impact with small overlap consist in generating a collision between a vehicle launched at 64 km/h against a rigid barrier with only 25% overlap of the front face of the vehicle. It is the most severe frontal impact protocol at present.

In a frontal impact, the forces are transmitted to the structure of the vehicle with a view to their absorption along three main force paths, namely: the upper path passing through the front longitudinal members, the lower path passing through the cradle extensions, and the third force path formed by a side slide that ensures the transmission of forces from the front support toward the A-pillar.

In the event the third force path is stressed, the wheel is quickly braced between the test barrier and the A-pillar and can follow a scenario known as crushing on the A-pillar (in which the wheel is embedded in the A-pillar) or a so-called avoidance scenario (in which the wheel is released toward the outside of the vehicle). In both cases, developments have been made to ensure the safety of vehicle users.

Thus, FR3058110 describes a motor vehicle having a reinforcement fixed to the A-pillar and to the wheelhouse. This reinforcement makes it possible to limit the intrusion of the front wheel into the passenger compartment in the event of a frontal collision by interfering with the front wheel. The rear of the front wheel presses against the reinforcement attached to the pillar and, depending on the force of the impact, the reinforcement prevents the rabbet of the A-pillar from opening. This reinforcement is therefore useful in the context of improving the resistance of vehicles in a crash-type scenario.

Furthermore, FR2994138 describes an arrangement for a motor vehicle comprising a wheel and a safety system, consisting of a wheelhouse screen inserted between the area to be protected and the wheel. The safety system is configured to vary between an active state and an inactive state in which the safety system respectively opposes and does not oppose a movement of the wheel toward the passenger compartment.

Nevertheless, it is preferable to prevent the front wheel from coming into contact with the A-pillar, which requires finding a solution so that the front wheel can completely release in the event of a frontal collision. It is in fact essential for the front wheel to escape to the outside of the vehicle in order to relieve the excessive loading of the A-pillar and the side member during impact.

In fact, heavy loading of the A-pillar and/or of the side member can generate significant intrusions into the passenger compartment, thus endangering the occupants of the vehicle. Force enters the A-pillar via the third force path. Force also enters via the front wheel by direct contact following bracing between the rim of said wheel and the A-pillar in the case of recoil of the wheel with bursting of the tire under the effect of the forces experienced. There is a risk of the wheel turning toward the inside of the vehicle or of the A-pillar becoming stuck between the inner and outer sidewalls of the wheel rim, blocking the possibilities of releasing the wheel toward the outside of the vehicle.

Freeing the wheel, allowing it to escape to the outside of the vehicle, would limit this loading and therefore preserve the integrity of the body and limit the risk of intrusion into the passenger compartment.

With this in mind, FR2892087 describes a front structure of a motor vehicle adapted to prevent the intrusion of a wheel into the passenger compartment in the event of a frontal impact. In this particular structure, the side members have been designed to be able to bend during a collision, which allows the front wheel to be offset from the passenger compartment. However, this solution does not make it possible to completely ensure the safety of the passenger compartment because the folding of the side members will necessarily affect the integrity of this passenger compartment.

Another approach is to cause the front wheel to release from the wheelhouse during a collision. FR2892691, for example, describes a front structure of a motor vehicle with a steering rack that has been provided with guide means making it possible, in the event of an impact, to act on the rods connecting the wheel and the rack in order to orient the rear of the front wheel outwards. During a collision, these guide means, which are in fact recesses in the crosspiece in an oblique direction, and in each of which recess is engaged a rack fixing element, will guide the movement of the rack so that the rod driven in this movement causes the front wheel to pivot so that the rear of the wheel is completely released from the wheelhouse. Nevertheless, these guide means limit the movement of the rack in a direction predefined by the direction of the recesses. Therefore, the described structure only makes it possible to release the front wheel that is on the same side as the steering shaft. Thus, in a vehicle adapted for driving on the right, and therefore with the steering wheel on the left, this type of guide means solves the problem only for the front left wheel.

### SUMMARY

The present invention therefore aims to provide a motor vehicle providing a solution to the problems encountered in the prior art. In particular, a vehicle designed to promote the release of the front wheel(s) from the wheelhouse during a frontal collision, for example of the small overlap type, is disclosed.

To this end, a motor vehicle comprises a front wheel provided with a rim with an inner sidewall, an underbody structure comprising a front longitudinal member, an A-pillar, and a connecting piece between said front longitudinal member and said A-pillar, the connecting piece being located at the back of the front wheel, wherein the connecting piece has a bearing element with a raised section projecting toward the front of the vehicle, said raised section extending in the transverse direction of the vehicle.

As will have been understood from reading the above description, the vehicle is equipped with passive means promoting a release of the front wheel to the outside in the event of a violent frontal impact, for example in the event of a small overlap frontal impact. To do this, a volume is added (by means of a raised section) at the connecting piece between the front longitudinal member and the A-pillar. This raised section (or volume) is configured (by its shape, its location and its dimensions) so as not to interfere with the movement of the wheel under normal driving conditions. In the context of wheel recoil kinematics following the forces due to the impact, the raised section is configured (by its shape, its location and its dimensions) to come into contact with the edge of the inner sidewall before the A-pillar engages (that is to say, prior to the A-pillar engaging) between the two inner and outer sidewalls of the wheel rim. In fact, it has been observed that the engagement of the A-pillar between the sidewalls of the rim prevented the subsequent release of the wheel toward the outside by blocking the pivoting movement of the wheel. The answer provided is to allow the inner sidewall to come into contact with the structure of the vehicle before the A-pillar enters the air gap formed by the two sidewalls of the rim. The backward movement of the front wheel toward the A-pillar is thus limited by the presence of said raised section or volume, and the front wheel is therefore free to perform the pivoting movement necessary for its release toward the outside of the vehicle.

Preferably, said raised section has an elongated shape between a first end located on the side of the front longitudinal member and a second end located on the side of the A-pillar, the width of the raised section being greater at the second end than at the first.

According to one embodiment, the connecting piece has a curved shape, and the raised section follows the curved shape of said connecting piece. The curved shape of the raised section will guide the pivoting of the wheel toward the outside of the vehicle.

Advantageously, said raised section protrudes toward the front of the vehicle by 1 mm to 4 mm with respect to the surface of the connecting piece, more preferentially between 1.5 mm and 3.5 mm, even more preferentially between 2 mm and 3 mm.

Preferably, said raised section protrudes toward the front of the vehicle in a constant manner over the entire length of said raised section.

Preferably, said bearing element extends over at least 80% of the length of said connecting piece, more preferably over at least 85% of the length, or over at least 90% of the length, or over at least 95% of the length, or over 100% of the length.

According to a first embodiment, the bearing element is integral with the connecting piece; preferably, the raised section of the bearing element is formed by stamping the connecting piece.

According to a second embodiment, the bearing element is a piece attached to said connecting piece; preferably, said bearing element is fixed to the connecting piece by at least one screw, at least one weld bead, and/or at least one spot weld. In this case, at least one of the following features can be used to define the bearing element:
The bearing element comprises at least one stiffening rib; preferably, the bearing element comprises at least one fixing lug and the stiffening rib(s) are arranged on the fixing lug(s).
The bearing element is a profile; preferably a profile with a section in the shape of a U or an uppercase omega.
The bearing element is made of very high elastic limit steel or high elastic limit steel; or the bearing element is made of plastic and/or aluminum.

According to another embodiment, complementary to the first two embodiments, the vehicle further comprises an apron adjacent to the A-pillar and delimiting the passenger compartment of the vehicle, wherein a reinforcing piece is fixed at least to the A-pillar and the apron; preferably, the reinforcing piece has a flange.

### DESCRIPTION OF THE FIGURES

The invention will be understood and other aspects and advantages will emerge on reading the following description, which is provided for the sake of example, with reference to the attached drawings, in which:

FIG. 1 is a view of a wheelhouse of the vehicle ; and

FIG. 2 is a view of a bearing element .

### DETAILED DESCRIPTION

In the following description, the term “comprise” is synonymous with “include” and is not limiting, in that it allows the presence of other elements in the vehicle. It will readily be understood that the term “comprise” includes the term “consist of.” Similarly, the terms “front,” “rear,” “longitudinal,” and “transverse” will be understood in relation to the general orientation of the vehicle as considered according to its normal direction of travel. In the various figures, the same references designate identical or similar elements.

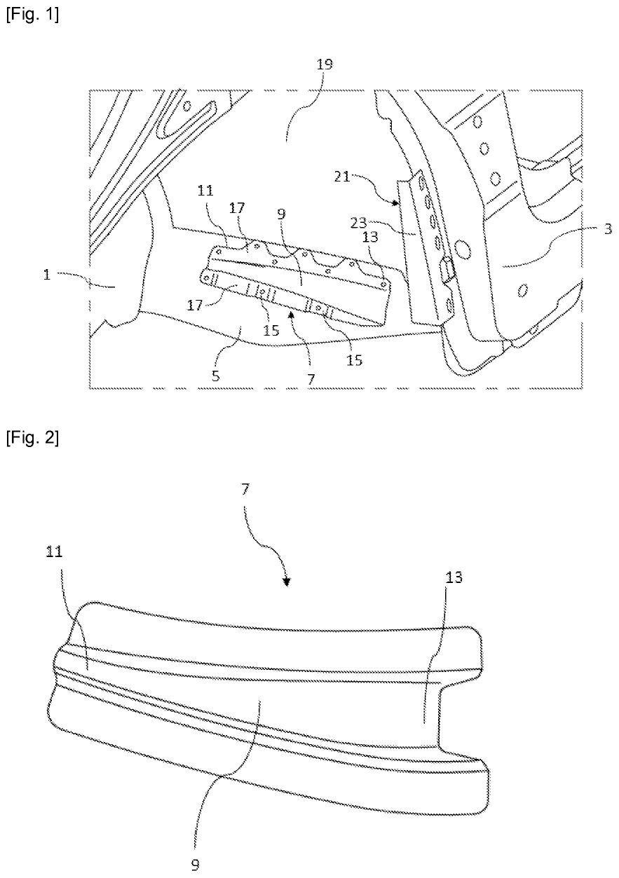

FIG. 1 shows a front wheelhouse of the vehicle, seen from the front to the rear of the vehicle. For the sake of clarity, the front wheel has not been shown, which makes it possible to see the underbody structure of the vehicle made up of a front longitudinal member 1, an A-pillar 3, and a connecting piece 5 between the front longitudinal member 1 and the A-pillar 3. The connecting piece 5 is located at the back of the front wheel. In order to favor the scenarios of releasing the front wheel toward the outside of the vehicle during a frontal collision, the connecting piece 5 has a bearing element 7 with a raised section 9 projecting toward the front of the vehicle and extending along the transverse direction of the vehicle. The bearing element 7 is therefore configured so that when the front wheel moves back toward the A-pillar, the inner sidewall of the rim of the front wheel is placed in contact with the raised section 9, preventing the A-pillar from fitting between the inner and outer sidewalls of the front wheel.

A certain advantage of such a configuration is that the bearing element can be integrated both on the left side and on the right side of the vehicle. Thus, the two front wheels of the vehicle have the same wheel release system in the event of a partial overlap frontal collision. Another advantage is that it is a passive, inexpensive security system that is easy to implement even on existing and light vehicles.

FIG. 2 shows the bearing element 7, from the rear of the vehicle. In this FIG. 2, the raised section 9 therefore appears to sink. The shape of the raised section 7 is elongated between a first end 11 located on the side of the front longitudinal member 1 (visible in FIG. 1) and a second end 13 located on the side of the A-pillar 13 (visible in FIG. 1). In order for the rear of the rim not to come into contact with the A-pillar 13 (visible in FIG. 1), the width of the second end 13 is wider than the width of the first end 11, such that when the wheel escapes, the rim thereof hits this second end 13 and is deflected outwards. Advantageously, the connecting piece 5 has a curved shape and the shape of the raised section 7 also has a curvature so as to follow the shape of the connecting piece 5.

The raised section 9 of the bearing element 7 can be 1 mm to 4 mm, more preferably by 2 mm to 3 mm, from the surface of the connecting piece 5 on which the bearing element is fixed. The volume thus created by the raised section makes it possible to deflect the wheel outwards. In general, the support surface that will come into contact with the front wheel on the raised section is arranged at a constant distance along the surface of the connecting piece 5.

The bearing element can extend over at least 80% of the length of said connecting piece 5, or over at least 90% of the length of said connecting piece, or over 100% of the length of said connecting piece.

A first way of incorporating this device on the vehicle is to integrate it directly into the connecting piece 5, for example by creating the raised section by stamping. This embodiment has the advantage of not having to add an additional part to the structure of the vehicle underbody and can be used during the manufacture of a new vehicle. This embodiment does not add weight to the vehicle.

Alternatively, the bearing element 7 can be a piece attached to said connecting piece 5, preferably fixed by at least one screw, at least one weld bead, and/or at least one spot weld. It is thus possible to equip vehicles already on the market with this safety system. The bearing element 7 may comprise at least one stiffening rib 15, preferably arranged on the fixing lug(s) 17 of the bearing element. With a view to reducing the weight of the vehicle, the bearing element may be a profile, in particular a profile with a U-shaped section or in the shape of an uppercase omega. The profile is arranged so that its section is open toward the connecting piece.

The bearing element 7 is made of steel; the steel is preferably selected from high-strength steels (HSS), very high-strength steels (VHSS), or ultra high-strength steels (UHSS). These steels have a fine-grained structure and exhibit excellent mechanical characteristics (yield strength, fatigue strength and resilience) as well as good formability.

As a reminder, mild steels exhibit an elastic limit ranging from 300 to 350 MPa, high-strength steels (HSS) exhibit an elastic limit ranging from 400 to 700 MPa, very high-strength steels (VHSS) exhibit a yield strength ranging from 800 to 1000 MPa, and ultra-high strength steels (UHSS) exhibit a yield strength of 1100 to 1500 MPa. The yield strength is measured according to ISO 6892-1:2016.

Alternatively, the bearing element 7 is made of plastic and/or aluminum, preferably a composite material based on plastic and aluminum. The presence of at least one stiffening rib 15 is particularly recommended when the bearing element 7 is made of plastic and/or aluminum. The lightness of these materials (plastic and/or aluminum) compared to the use of rigid steel is an attractive property in motor vehicle design, particularly from an ecological point of view. An example of plastic used is dense polypropylene foam.

In general, the presence of the bearing element 7 proved its usefulness when a safety test involving a small overlap frontal collision was carried out at a speed of 64 km/h.

In order to reinforce the underbody structure and to anticipate the eventuality of the frontal impact resulting in crushing of the front wheel on the A-pillar, it is possible to install a reinforcing piece 21, for example made from DP450 steel, or dense polypropylene foam, at least at the A-pillar 3 and the apron 19 of the vehicle. More details about this reinforcing piece 21 are available in FR3058110, which is incorporated here by reference.

Preferably, the reinforcing piece 21 comprises a flange 23 that allows the front wheel to be engaged during the frontal collision. When the raised section 9 of the bearing element 7 extends toward the front of the vehicle over a distance equivalent to the distance reached by the extension of the flange 23 toward the front of the vehicle, the flange 23 and the raised section 9 of the bearing element 7 can both participate in the release of the front wheel during a partial overlap frontal collision. Indeed, in this case, the bearing volume formed by the presence of the raised section 9 on the connecting piece 5 is extended by the flange 23 of the reinforcing piece 21.

1. A motor vehicle comprising a front wheel provided with a rim with an inner sidewall, an underbody structure comprising a front longitudinal member, an A-pillar, and a connecting piece between said front longitudinal member and said A-pillar, the connecting piece being located at the back of the front wheel, wherein the connecting piece has a bearing element with a raised section projecting toward the front of the vehicle, said raised section extending in a transverse direction of the vehicle.

2. The motor vehicle according to claim 1, wherein the connecting piece has a curved shape, and wherein the raised section follows the curved shape of said connecting piece and/or said raised section has an elongated shape between a first end located on the side of the front longitudinal member and a second end located on the side of the A-pillar, the width of the raised section being greater at the second end than at the first end.

3. The motor vehicle according to claim 1, wherein said raised section protrudes toward the front of the vehicle by 1 mm to 4 mm with respect to the surface of the connecting piece; and/or said raised section protrudes toward the front of the vehicle in a constant manner over the entire length of said raised section.

4. The motor vehicle according to claim 1, wherein the bearing element is integral with the connecting piece; the raised section of the bearing element being formed by stamping the connecting piece.

5. The motor vehicle according to claim 1, wherein said bearing element is a piece attached to said connecting piece; said bearing element being fixed to the connecting piece by at least one screw, at least one weld bead, and/or at least one spot weld.

6. The motor vehicle according to claim 5, wherein the bearing element comprises at least one stiffening rib; and wherein the bearing element comprises at least one fixing lug and the at least one stiffening rib is arranged on the at least one fixing lug.

7. The motor vehicle according to claim 5, wherein the bearing element is a profile.

8. The motor vehicle according to claim 5, wherein the bearing element is made of very high elastic limit steel or high elastic limit steel; or the bearing element is made of plastic and/or aluminum.

9. The motor vehicle according to claim 1, wherein the bearing element extends over at least 80% of the length of said connecting piece.

10. The motor vehicle according to claim 1, wherein the vehicle further comprises an apron adjacent to the A-pillar and delimiting the passenger compartment of the vehicle, said vehicle further comprising a reinforcing piece fixed at least to the A-pillar and the apron.

11. The vehicle according to claim 7, wherein said profile define a section in the shape of a U or an uppercase omega.

12. The motor vehicle of claim 10, wherein the reinforcing piece has a flange.
